(19) United States
(12) Patent Application Publication
(10) Pub. No.: US 2008/0048636 A1
(43) Pub. Date: Feb. 28, 2008

(54) Method and apparatus for silicon-on-insulator material characterization

(75) Inventors: Edward Tsidilkovski, Chelmsford, MA (US); Kenneth Steeples, Billerica, MA (US)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: QC Solutions, Inc., Billerica, MA (US)

(21) Appl. No.: 11/894,032

(22) Filed: Aug. 16, 2007

Related U.S. Application Data
(60) Provisional application No. 60/838,616, filed on Aug. 18, 2006.
(60) Provisional application No. 60/880,855, filed on Jan. 17, 2007.

(51) Int. Cl. G01J 1/42

(52) U.S. Cl. 324/71.5

(57) ABSTRACT

A method and apparatus for thickness measurement of an active layer of a silicon-on-insulator material comprising a layered structure of silicon film, a buried oxide layer and a silicon substrate. In one embodiment, the method comprises the steps of directing a low intensity light of an energy greater than the silicon band-gap on the silicon film, the energy of light sufficient to be substantially absorbed within the silicon film such that the error from the substrate excitation is small compared to the small signal calibration of the apparatus; modifying the surface potential with the chemical treatment, electrical bias or corona, measuring surface photovoltage of the silicon film; and calculating the thickness of the silicon film in response to a non-contact photovoltage measurement of the semiconductor layered structure.

### RELATED APPLICATIONS

This application claims priority to and the benefit of U.S. provisional patent application Nos. 60/838,616, filed on Aug. 18, 2006, and 60/880,855, filed on Jan. 17, 2007, the entire disclosures of which are incorporated by reference herein.

### FIELD OF THE INVENTION

The invention relates to a method of characterizing silicon-on-insulator material, and specifically to a method of measuring the thickness of a silicon-on-insulator (SOI) layer using a sub-surface photovoltage (PV).

### BACKGROUND OF THE INVENTION

In modern silicon-on-insulator (SOI) based devices, two parameters are considered as the most critical: the silicon film thickness and the buried oxide (BOX)/silicon film interface defectiveness. Their accurate determination is especially important for the ultra-thin fully depleted SOI when the transistor threshold voltage is linked to the SOI thickness. Therefore, the main challenge for SOI metrology is a precise control of a silicon film thickness across the entire wafer. Currently there are two common techniques used to measure film thickness uniformity: spectral ellipsometry and spectral reflectometry. These methods are sensitive to the native oxide variations, surface roughness and require additional data (reflectometry) for the accurate analysis.

The ac surface photovoltage (SPV) technique traditionally used for bulk silicon wafers, as described in U.S. Pat. No. 5,661,408, can be applied, as well, to film characterization. Though until now, the use of SPV-based methods was applied to thick films/SOI only. In other words, the thickness of the film has to be greater than the sum of the two depletion layers associated with the surface and the BOX/silicon film interface (partially depleted SOI). As such, the SOI measurement with the SPV technique is essentially similar to the bulk wafer measurement, which allows determining such material parameters as doping concentration and carrier lifetime, where the light is typically contained in the surface layer of a many layer semiconductor wafer. Experiments performed to date by various researchers identify difficulties associated with such an approach to generate accurate results with respect to buried oxide wafers.

The present invention addresses these issues.

### SUMMARY OF THE INVENTION

The invention relates to methods and apparatus described herein that can provide photon generation and measure the associate electrical effects at the interface between each of the different layers of a semiconductor wafer. Specifically, one embodiment of the invention measures the modulation of photo-generated charge at the interfacial junction of two materials for the purpose of assessing the thickness and relative positions of one or more constituent SOI layers.

In one aspect, a method for thickness measurement of a silicon-on-insulator material comprising a layered structure of silicon film, a buried oxide layer and a silicon substrate is provided. In one embodiment, the method comprises the steps of directing low intensity light of an energy greater than the silicon band-gap on the silicon film, the energy of light sufficient to be substantially absorbed within the silicon film, and the absorption and carrier excitation in the silicon below the oxide to be small enough so as not to cause an appreciable error in the linearity of a signal calibration of the thickness measurement. Non-contact measurement of a photovoltage response of the silicon film (V_{PV}); and allows a relative calibration of the thickness of the silicon film.

In another embodiment, method comprises the step of modifying the potential with the chemical treatment, electrical bias or corona, measuring a photovoltage and calculating the thickness of the silicon film by using the formula:

$${W}_{d 2} \sim - \frac{{V}_{M} ɛω}{e Φ}$$

Where V_{M}=V_{PV1}−V_{PV2}, V_{PV1} and V_{PV2} are the photovoltages generated at the surface and BOX/silicon film interface respectively, ε is a silicon permittivity, ω is a light modulation frequency, e is the elementary charge, Φ is a light flux, and W_{d2} is the depletion depth associated with the BOX/film interface. In yet another embodiment, the method further comprises the step of modulating the light at a frequency that excludes the surface/interface states lifetime effects and correlates the measured photovoltage to the film space charge capacitance.

In another aspect, an apparatus adapted for thickness measurement of a silicon-on-insulator material comprising a layered structure of silicon film, a buried oxide layer and a silicon substrate is provided. The apparatus comprises a light source adapted to produce light having an energy greater than the silicon band-gap on the silicon film and is sufficient to be substantially absorbed within the silicon film; a photovoltage measuring device adapted for measuring a photovoltage response of the silicon film from the multi-layer structure; and a processor adapted to calculate the thickness of the silicon film in response to the photovoltage of the silicon film.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a sectional diagram of an SOI based device, according to an embodiment of the invention;

FIG. 2 is a block diagram illustrating an apparatus for measuring the thickness of a silicon-on-insulator material, according to an embodiment of the invention; and

FIG. 3 is a diagram illustrating the correlation of ac PV measured thickness of an SOI layer and spectral reflectometer measured thickness of the SOI layer.

### DETAILED DESCRIPTION

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

The invention relates to a method of measuring the thickness of the active silicon layer of a silicon-on-insulator structured wafer using a sub-surface photovoltage technique in the accumulation regime. The accumulation regime refers to the state that occurs when a voltage of opposite polarity is applied to a portion of a wafer to attract charges into a region. In depletion mode, when a like charge is applied to the wafer to cause the repulsion of like charges from a region, the method allows measurement of the spatial uniformity across the wafer of charge states associated with the buried oxide layer. Specifically, for a p-type wafer a negative corona can be applied to attract positive charges (accumulation). In contrast, for a p-type wafer, a positive corona can be applied to repel charges from a particular region.

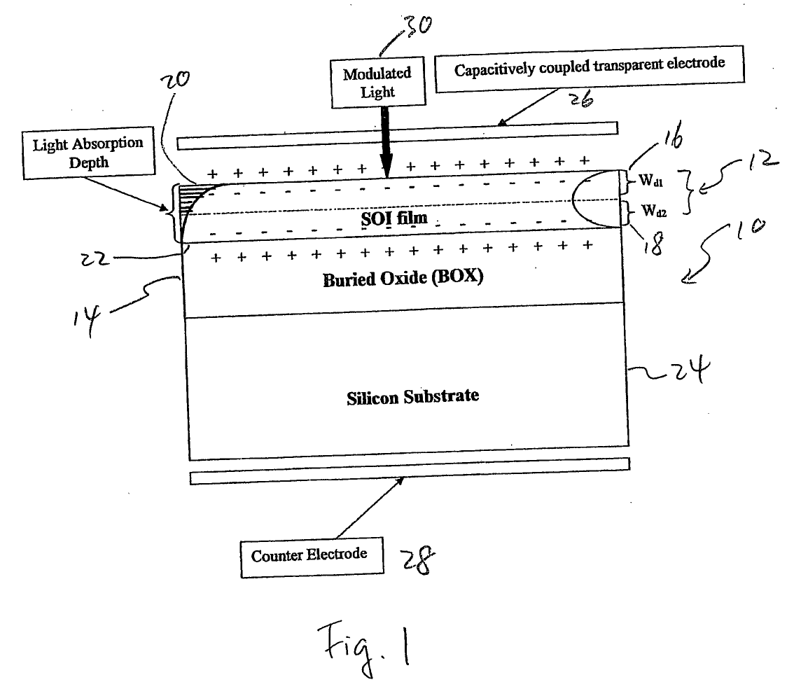

Aspects of the invention extend the applicability of electromagnetic radiation induced photovoltage (PV) based metrology methods to various wafers having embedded layers. An example of an SOI wafer configured for a metrology analysis is shown in FIG. 1. Specifically, FIG. 1 shows a sectional diagram of an SOI wafer 10 having an SOI film 12 formed on a buried oxide layer 14 (BOX). The thicknesses, W_{d1} and W_{d2}, shown as layers 16, 18 within the SOI film 12, correspond to the depletion depths associated with the surface 20 and the interface 22 of the SOI film 12 and the BOX 14 (discussed below). As shown, the buried oxide layer 14 is adhered, grown, or otherwise formed on the silicon substrate 24. A capacitively coupled electrode 26 and a counter electrode 28 are coupled to the SOI film layer 12 and the bulk silicon substrate 24, respectively. These electrodes 26, 28 in combination with the modulated light 30 are used to perform the metrology steps described in more detail below. The light 30 is modulated to facilitate the extraction of fundamental photovoltage components, in the small signal regime.

In part, the invention relates to the selection of the appropriate electromagnetic wavelengths to perform a metrology analysis on a SOI wafer using a non-contact photovoltage based approach. Specifically, to perform sub-surface SOI wafer photovoltage based metrology wavelengths in the range of about 150 nm to about 400 nm can be used. In general, wavelengths in the range of about 350 nm to about 380 nm provide enhanced measurement accuracy. In general, longer wavelengths are used to modulate the substrate photovoltage when performing photovoltage measurements on an SOI wafer. In contrast, shorter wavelengths are used to modulate the active layer photovoltage.

Aspects of the invention extend PV methods to thin and ultra-thin SOI material. Thin SOI material has a thickness range of from about 20 nm to about 100 nm. In contrast, ultra-thin SOI material has thickness range of about 10 nm to about 20 nm. Obtaining information about the depth and thickness of the buried oxide layer in an SOI or other embedded wafer is valuable because it informs the etching process used to fabricate circuits on the surface of the SOI wafer.

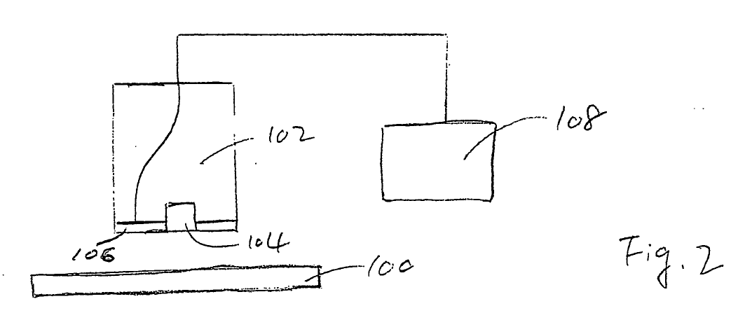

In one embodiment, referring to FIG. 2, the apparatus 102 to perform various electrical characterizations uses the method for measuring the PV at the surface of SOI material 100. This apparatus 102 includes a light source 104 directed at the surface of the SOI material 100. In operation, a beam of light is shined at a region of the surface of the SOI material 100 and the photo-induced change in electrical potential at the surface is detected by another component of the apparatus 102—a photovoltage-measuring device 106. The measurements are then analyzed by a microprocessor 108, which makes calculations to obtain the desired electrical characterization of the SOI material 100.

In order to generate a photovoltage in a SOI structure, the low intensity light with energy greater than a silicon band-gap is shined on a top silicon film. The light photon energy is also high enough to allow substantial light absorption within the silicon film, the buried oxide layer and sub oxide silicon, such that the error from carrier excitation in the sub-oxide silicon is negligible to the signal calibration for thickness measurement. Light with energy greater than approximately 3 eV can be used to measure thin SOI active layer thickness. This is relevant for current “partially” depleted and “fully “depleted SOI structures with active layers greater than 10 nm. Light of this wavelength is chosen because it enhances the quality of information available with respect to the active layer. Also, this type of light can substantially minimize the contribution of the wafer substrate.

The formula

$${V}_{PV} \sim \frac{e Φ}{ɛω} {W}_{d}$$

is derived from the standard analysis of a small signal high frequency PV in bulk silicon. In this formula, V_{PV} is a photovoltage, typically either surface or sub-surface, e is the elementary charge, Φ is a light flux, ε is a silicon permittivity, ω is a light modulation frequency. When using a photovoltage in a thin film/SOI, even a short wavelength light that is fully absorbed in a silicon film may generate photovoltages in both the surface and the BOX/silicon interface. When both space charge regions—surface and interface associated—are in depletion, the signs of the respective V_{PV} are opposite. As a result, a measured photovoltage V_{M} can be presented as a difference of the two photovoltages V_{M}=V_{PV1}−_{PV2} that yields:

$${V}_{M} \sim \frac{e Φ}{ɛω} [ {W}_{d 1} - {W}_{d 2} exp ( - α {W}_{d 1} ) ] ,$$

where α is a light absorption coefficient, W_{d1} and W_{d2} are the depletion depths associated with the surface and the interface. In the thin/ultra-thin SOI wafer the top silicon film is fully or nearly fully depleted. Thus, there is almost no majority carriers left in the film and the depletion areas are fixed. In the ideal case of a fully depleted SOI (W_{d1}/W_{d2}=const), a measured PV signal yields the depletion layer width, and the silicon film thickness can be calculated through calibration to reference values obtained from controlled experiment in which PV signals are measured for silicon films of known thickness.

In reality, the minimal amount of remaining majority carriers allows changing the ratio of W_{d1}/W_{d2} by modifying a potential. The potential, in turn, can be adjusted by chemical treatment, external bias, or corona charge. To maintain a true non-contact approach, a corona charge is chosen as a preferred method for a voltage modulation. The native oxide or artificially grown photo-oxide can be used to retain corona charges on the surface. By applying corona charge of the appropriate polarity a surface depletion layer can be modified from the maximum value (determined by the BOX charge) to the minimum, close to zero, value (flat band condition). In the first case, variations in the BOX charge may dominate the PV signal, allowing calculation of the uniformity distribution of the BOX charge from the analysis of a photovoltage wafer map.

When a depletion layer is minimized, the photovoltage measurement yields the interface depletion width:

$${W}_{d 2} \sim - \frac{{V}_{M} ɛω}{e Φ} ,$$

independent of the BOX charge variations. Since the silicon film thickness d=W_{d1}+W_{d2}, and W_{d1}˜0 in this condition, meaning that the depletion layer associated with BOX/film interface extends to the front surface, one can accurately determine the thickness of an SOI film by measuring the PV.

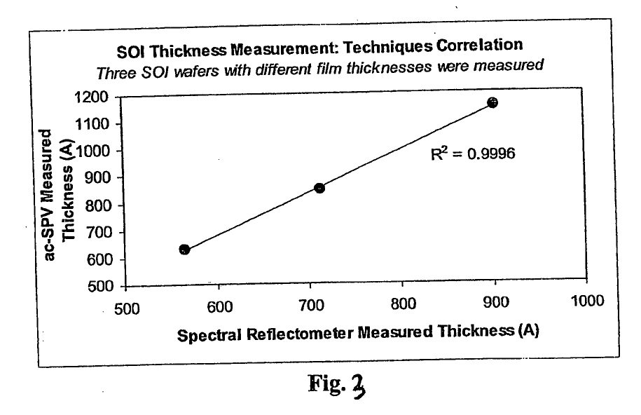

Referring to FIG. 3, the relationship is illustrated when a non-contact ac photovoltage measured thickness is plotted against spectral reflectometer measured thickness. It will be noted that although there is a difference in measurements (e.g., the first wafer has a spectral reflectometer measured thickness of about 560 Å while the ac-SPV measured thickness is about 625 Å) that difference is linear to a high degree correlation (R²=0.9996). Hence the actual (spectral reflectometry value) may be determined from the ac-SPV value by simply adding or subtracting a fixed offset depending on the calibration of the ac-SPV device.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method for thickness measurement of a silicon-on-insulator material comprising a layered structure of silicon film having a silicon band-gap, a buried oxide layer (BOX) and a silicon substrate, the silicon film and the BOX having a BOX/silicon film interface, the method comprising the steps of:
directing low intensity light of an energy greater than the silicon band-gap on the silicon film, the energy of the light sufficient to be substantially absorbed within the silicon film and the buried oxide layer and the silicon substrate;
measuring the photovoltage of the silicon film and the charge modulations of the BOX; and
calculating the thickness of the silicon film in response to the photovoltage.

2. The method of claim 1 further comprises the step of modifying the photovoltage with a chemical treatment, electrical bias or corona in such a way that a depletion layer associated with the BOX/silicon film interface extends to the surface of the material.

3. The method of claim 1 wherein the step of calculating utilizes the equation
$${W}_{d 2} \sim - \frac{{V}_{M} ɛω}{e Φ} ,$$
where V_{M}=V_{PV1}−V_{PV2}, V_{PV1} and V_{PV2} are the photovoltages generated at the surface of the silicon film and the BOX/silicon film interface respectively, ε is a silicon permittivity of the silicon film, ω is a light modulation frequency of the light, e is the elementary charge, Φ is a light flux, and W_{d2} is the depletion depth associated with the BOX/film interface.

4. The method of claim 1 further comprises the step of modulating the light at a frequency that excludes the silicon surface/interface states lifetime effects and correlates the measured photovoltage to the film space charge capacitance.

5. An apparatus adapted for electrical characterization of a silicon-on-insulator comprising a layered structure of silicon film having a silicon band-gap, a buried oxide layer (BOX) and a silicon substrate, the apparatus comprising:
a light source adapted to produce light having an energy greater than the silicon band-gap on the silicon film and sufficient to be substantially absorbed within the silicon film, the BOX and the silicon substrate;
a photovoltage measuring device adapted for measuring photovoltage of the silicon film; and
a processor adapted to calculate the thickness of the silicon film in response to the photovoltage of the silicon film.

6. The apparatus of claim 5 wherein the processor utilizes the equation
$${W}_{d 2} \sim - \frac{{V}_{M} ɛω}{e Φ}$$
where V_{M}=V_{PV1}−V_{PV2}, V_{PV1} and V_{PV2} are the photovoltages generated at the surface and BOX/silicon film interface respectively, ε is a silicon permittivity of the silicon film, ω is a light modulation frequency of the light, e is the elementary charge, Φ is a light flux, and W_{d2} is the depletion depth associated with the BOX/film interface.

7. An apparatus adapted for electrical characterization of a silicon-on-insulator comprising a layered structure of silicon film, a buried oxide layer (BOX) and a silicon substrate, the apparatus comprising:
means for directing low intensity light of an energy greater than the silicon band-gap on the silicon film, the energy-of light sufficient to be substantially absorbed within the silicon film, the BOX and the silicon substrate;
means for measuring photovoltage response of the silicon film; and
means for calculating the thickness of the silicon film in response to a photovoltage of the silicon film.

8. The apparatus of claim 7 wherein the means for calculating utilizes the equation
$${W}_{d 2} \sim - \frac{{V}_{M} ɛω}{e Φ}$$
where V_{M}=V_{PV1}−V_{PV2}, V_{PV1} and V_{PV2} are the photovoltages generated at the surface and BOX/silicon film interface respectively, ε is a silicon permittivity of the silicon film, ω is a light modulation frequency of the light, e is the elementary charge, Φ is a light flux, and W_{d2} is the depletion depth associated with the BOX/film interface.
